(19) United States
(12) Patent Application Publication
(10) Pub. No.: US 2009/0122031 A1
(43) Pub. Date: May 14, 2009

(54) SCROLL DEVICE AND METHOD OF USING THE SAME

(75) Inventor: Jung-Hyun LEE, Seoul (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/267,823

(22) Filed: Nov. 10, 2008

(30) Foreign Application Priority Data
Nov. 12, 2007 (KR) 10-2007-0115099

(51) Int. Cl. G06F 3/033

(52) U.S. Cl. 345/184

(57) ABSTRACT

A scroll device and a scroll method are provided. The scroll device includes a scroll button installed and partially projected on the case frame of an apparatus, the scroll button being able to move in forward and backward directions by manipulation, a sensing means for detecting the movement of the scroll button and a control unit for scrolling displayed information on a display unit of the apparatus in predetermined direction corresponding to the detecting signal of the sensing means.

### PRIORITY

This application claims the benefit under 35 U.S.C. §119(a) of a Korean patent application filed in the Korean Intellectual Property Office on Nov. 12, 2007 and assigned Serial No. 10-2007-0115099, the entire disclosure of which is hereby incorporated by reference.

### BACKGROUND OF THE INVENTION

1. Field of the Invention:

The present invention relates to a scroll device and method of using the same. More particularly, the present invention relates to a scroll device and method for improving its utilization by facilitating the scroll function.

2. Description of the Related Art:

Recently, with the advances made in the area of wireless communication technology, portable terminals are able to provide many diverse functions. However, while the additional functions provide greater and more efficient services for the user's enjoyment, the many additional functions may overwhelm a user. Therefore, the portable terminal requires a means to manage the functions effectively and conveniently.

For example, besides a basic telephone call function, portable terminals are now able to provide many diverse functions, such as a Multimedia Messaging System (MMS), a digital camera, an MP3 player, a Digital Multimedia Broadcasting (DMB) system, a video clip player, etc.

To support all of these additional functions, portable terminals also have the ability to accept memory cards, such as mini SD, memory stick Duo, etc. so that the portable terminal in order to store data and program files associated with the additional functions. However, in light of the additional data and programs stored in the supplemental memory, the portable terminal needs advanced searching functions such as functions for searching the files during the play of video clip or MP3 file.

When the various additional functions are being used or the enhanced memory is being searched, a large amount of data may be available for the user to view. The amount of data may be so large that it is not possible to display it all on one screen. To allow the user to view all of the information in such a situation, portable terminals are often provided with a scroll device. By using a scroll device, a user is able to scroll through and read the information that is originally presented off screen because the display unit is not able to display all the information at one time, for example if it is not able to display all the search results after it performs a search for specific files.

The scroll device in a portable terminal may include one or more of various types of scroll functions. For example, the scroll device may include an upper and lower scroll button type, a dial wheel type, a touch inputting type, a side wheel type, etc. However, each type has a drawback. For example, a portable terminal using the upper and lower scroll button type scrolls the display according to a press on one of the scroll buttons. Consequently, many repeated presses of the button are required if a large scrolling distance is required.

Also, a portable terminal using a dial wheel type needs large space for the wheel which reduces an amount of space for other desired features, such as the display.

A portable terminal using a touch inputting type has a smooth surface which causes an inconvenience in its operation.

A portable terminal using a side wheel type is typically activated by a user's finger, thus causing an inconvenience and fatigue for the user's finger. Moreover, if the wheel is installed on the front side of the portable terminal, the terminal thickness increases thus reducing its portability, and a space is now required, thus reducing space for other features similar to the dial wheel type.

### SUMMARY OF THE INVENTION

An aspect of the present invention is to address at least the above-mentioned problems and/or disadvantages and to provide the advantages described below. Accordingly, an aspect of the present invention is to provide a portable terminal and scroll method to execute a quick search using a scroll device.

Another aspect of the present invention is to provide a portable terminal and scroll method to provide user convenience when the scroll is demanded on various applications.

In accordance with an aspect of the present invention, a scroll device is provided. The scroll device includes a scroll button installed and partially projected on a case frame of an apparatus, the scroll button being able to move in forward and backward directions by manipulation, a sensing means for detecting the movement of the scroll button, and a control unit for scrolling displayed information on a display unit of the apparatus in a direction corresponding to the movement detected by the sensing means.

In accordance with another aspect of the present invention, a portable terminal is provided. The portable terminal includes a main body having a display unit, a scroll device installed on an area of the main body, wherein the scroll device comprises, a scroll button installed and partially projected on the a case frame of an apparatus, the scroll button being able to move in forward and backward directions by manipulation, a sensing means for detecting the movement of the scroll button, and a control unit for scrolling displayed information on a display unit of the apparatus in predetermined a direction corresponding to the detecting signal of the sensing means.

In accordance with another aspect of the present invention, a method for scrolling of a scroll device including a scroll button installed and partially projected on the case frame of an apparatus, the scroll button being able to move in forward and backward directions by manipulation, a sensing means for detecting the movement of the scroll button and a control unit for scrolling displayed information on a display unit of the apparatus in a direction corresponding to the detecting signal of the sensing means is provided. The method includes detecting a movement of the scroll button, and scrolling displayed information on the display unit of the apparatus corresponding to a detection signal of the sensing means.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments the present invention will be more apparent from the following description taken in conjunction with the accompanying drawings, in which:

FIG. 1 illustrates a perspective view of a portable terminal according to an exemplary embodiment of the present invention;

FIG. 2 illustrates a schematic perspective view of a scroll device according to an exemplary embodiment of the present invention;

FIG. 3 illustrates a perspective view of a scroll button of a scroll device according to an exemplary embodiment of the present invention;

FIG. 4A illustrates a perspective view of a cross-section A-A′ of FIG. 3 in direction E;

FIG. 4B illustrates a perspective view of a cross-section B-B′ of FIG. 3 in direction E;

FIG. 4C illustrates a perspective view of a cross-section C-C′ of FIG. 3 in direction S;

FIG. 5 illustrates an operative view of a sensor unit of a scroll device according to an exemplary embodiment of the present invention;

FIG. 6 illustrates a block diagram of a portable terminal according to an exemplary embodiment of the present invention;

FIG. 7 illustrates a flow chart of a scroll method according to an exemplary embodiment of the present invention; and

FIG. 8 illustrates a scrolling operation of a scroll module according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

While a scroll device is described as being installed in a slide type portable terminal by way of example, the present invention is not limited to the slide type portable terminal. For instance, exemplary embodiments of the present invention are applicable to any portable terminal, such as a bar type portable terminal, a folder type portable terminal and the like.

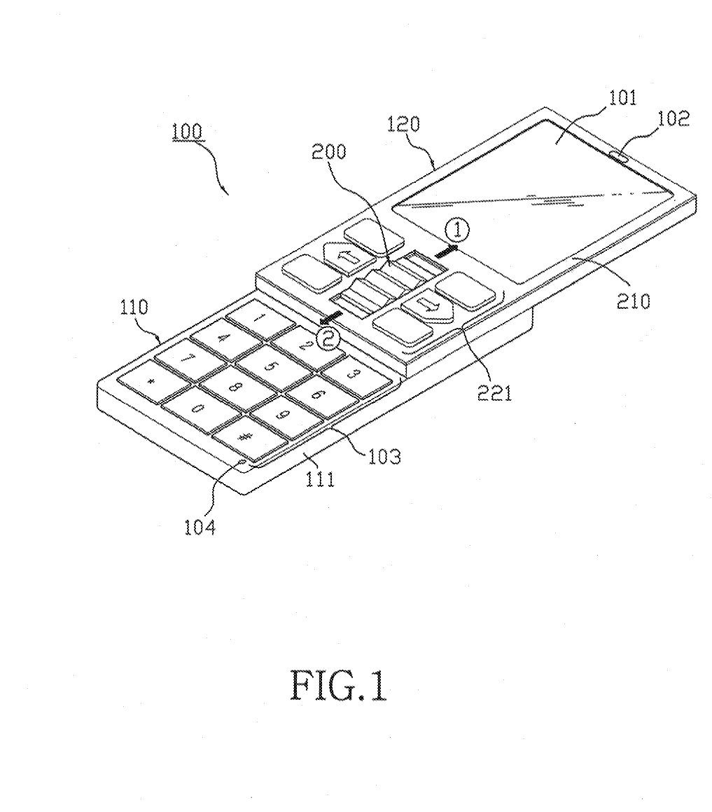

FIG. 1 illustrates a perspective view of a portable terminal according to an exemplary embodiment of the present invention.

Referring to FIG. 1, the portable terminal 100 includes a lower body 110 which includes a plurality of key buttons 103, such as a menu button, a dial button, etc., in front side of the portable terminal.

Also, the portable terminal 100 includes an upper body 120 which may slide longitudinally over the lower body 110. The plurality of key buttons 103 may be installed on a surface of the lower body 110 viewed when the upper body 120 is opened on the lower body 110.

The lower body 110 includes the plurality of key buttons 103 for inputting data and a transceiver 104 that transmits a voice of a user to another party.

Also, the lower body 110 includes an antenna device (not shown) installed on the lower body 110 for receiving a communication signal, and a main board for controlling various functions. Furthermore, the lower body 110 includes a battery pack (not shown), i.e., a power supply unit of the main board which is detachably installed at a rear surface of the lower body 110, and a case frame 111 adapting the main board.

The upper body 120 includes a display unit 101, which is installed on a front surface of the upper body 120, for displaying various image information, a speaker 102 for outputting a voice of another party, and a case frame 210 for adapting and supporting the display unit 101 and the speaker 102.

In an exemplary implementation of the present invention, a scroll device 200 may be installed on a location of the upper body 120 and various functional buttons 221 may be arranged in proximity to the scroll device 200.

The display unit 101 may be provided as a Liquid Crystal Display (LCD). In this case, the display unit 101 may include a controller for controlling the LCD, a video memory in which image data is stored and an LCD element. If the LCD is provided as a touch screen, the display unit 101 may perform a part or all of the functions of the plurality of key buttons 103.

The display unit 101 displays various information such as a document, a text message, a video clip, a page downloaded from the Internet, and the like. If the amount of information set for display is greater than the amount of information that may be viewed on the display at one time, the scroll device may be used. Consequently, the scroll device 200 of an exemplary embodiment of the present invention provides added convenience for the user.

For instance, if it is desired to move the displayed information in direction \textcircled{1} (upper direction) or in direction \textcircled{2} (lower direction), the scroll button of the scroll device 200 may be moved in a corresponding upper or lower direction.

Furthermore, according to the location of the scroll button, a scroll speed may be controlled. More specifically, a sensor may be installed to detect the location of the scroll button, so that the scroll speed may be controlled by operating a specific scroll module in accordance with an output signal of the sensor. For example, when the user raises the scroll button to a maximum position, information which is displayed in the display unit moves at the quickest speed.

The scroll button may include a return means for automatically returning the scroll button to a desired or original location. Consequently, the return means returns the scroll button to the original position for example, automatically after operation and release of the scroll button.

In an exemplary implementation of the present invention, the portable terminal 100 uses the scroll device when it is desired to scroll in the upper and lower directions. Furthermore, the functional buttons 221 may be used when it is desired to scroll in the right and left directions. Also, the scroll device 200 may be installed in any location that allows for ease of its operation.

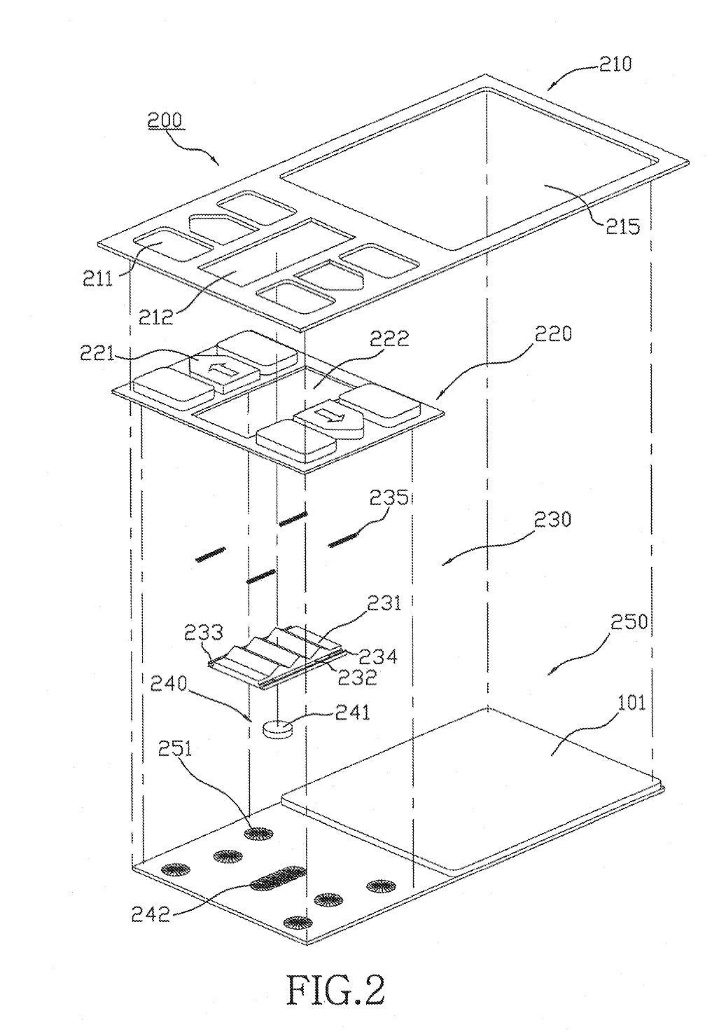

FIG. 2 illustrates a schematic perspective view of a scroll device according to an exemplary embodiment of the present invention.

Referring to FIG. 2, the scroll device 200 includes a case frame 210, a button pad 220, a scroll button 230, a sensor unit 240, and a main board 250.

The case frame 210 includes a through hole 212 for allowing an operating part 231 of the scroll button 230 and a display unit 101 of the main board 250 to protrude at the case frame 210. More particularly, the through hole 212 of the case frame 210 is formed having a size that allows the scroll button 230 to be able to move.

A plurality of buttons 221 are formed at the button pad 220. Also, a through hole 222 is formed at the button pad 220 for the scroll button 230 to be moved without disturbance.

When the user presses the button 221, an inputting means (e.g. a metal dome) which is installed in the main board 250 is pressed, and the portable terminal receives a corresponding input signal.

As set forth above, when information is displayed on the display unit of the portable terminal, it may be scrolled in a movement corresponding to movement of the scroll button 230.

The operating part 231 is projected to penetrate the through hole 212 of the case frame 210. The operating part 231 may have protrusions for an easy operation. Also, in order for the operating part 231 not to be detached from the through hole 212 of the case frame 210, a plate 232 is formed on a lower portion of the operating part 231.

The scroll button 230 includes the return means that returns the scroll button to the original position automatically after operation of the scroll button. This function is called self-centering. The return means may use a tension coil spring 235. Also, a compression coil spring may be used.

As an exemplary implementation of the present invention, the self-centering function will be described herein below with reference to the accompanying drawings.

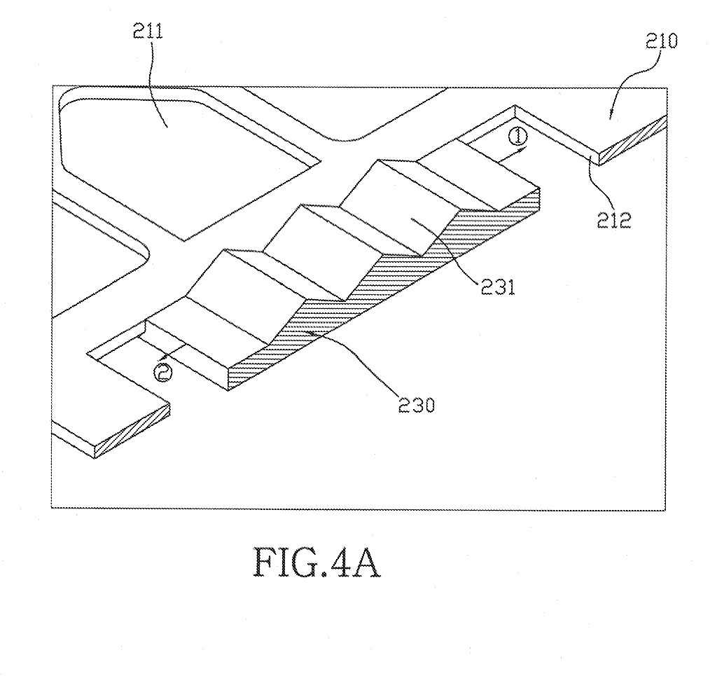

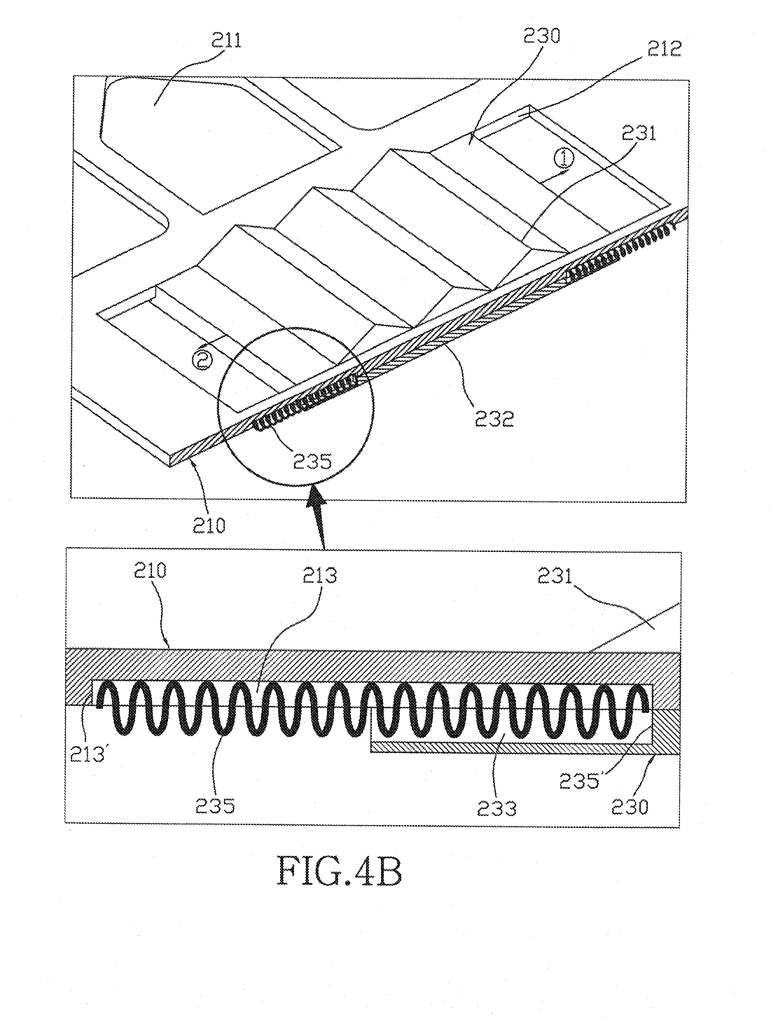

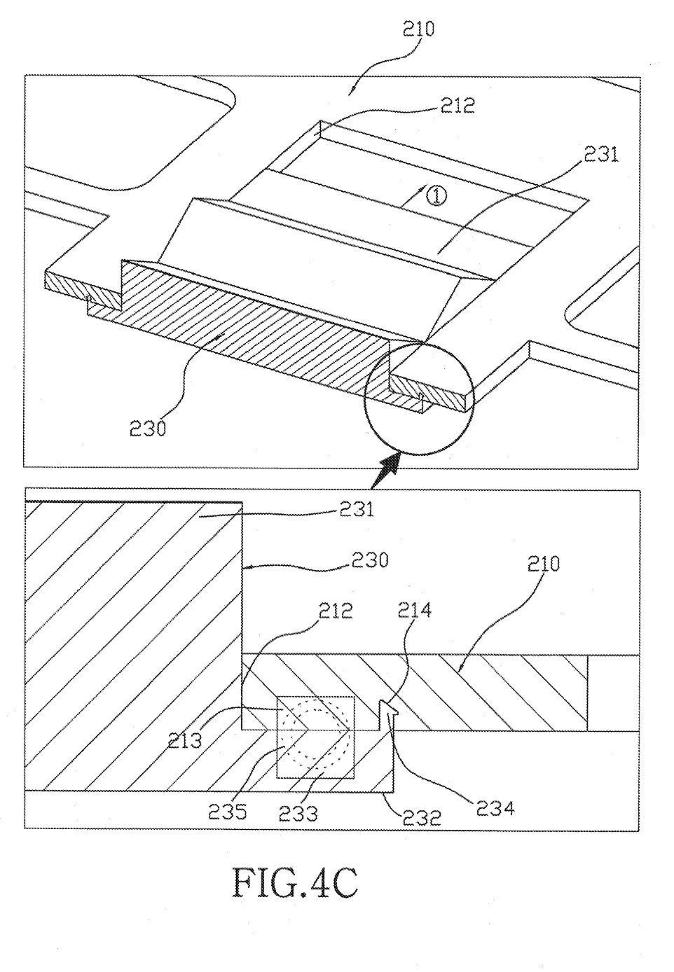

Four spring grooves 233 are formed on the plate 232 and the four tension springs 235 are partially adapted to the spring grooves 233. Also, the spring grooves (213 of FIG. 4B) are formed on the case frame 210 and the four tension springs 235 are also partially adapted to the spring grooves 213.

Consequently, when the scroll button 230 is combined with the case frame 210, the tension springs 235 are installed at the spring grooves 233 of the plate 232 and the spring grooves 213 of the case frame 210.

In an exemplary implementation, one end of the tension springs 235 is fixed on a cut-off (235′ of FIG. 4B) of the spring grooves 233 of the plate 232 and another end of the tension springs 235 is fixed on another cut-off (213′ of FIG. 4B) of the spring grooves 213 of the case frame 210.

For example, when the scroll button 230 moves, one of the tension springs 235, which is located in moving direction of the scroll button 230, will be compressed, and the other of the tension springs 235, which is located in an opposite direction, will be extended.

Consequently, when user takes off his hand, the scroll button 230 is returned to its original location automatically. As shown, the tension springs 235 may use coil springs.

Also, a projection 234 is formed at the plate 232 for moving in an upper and lower direction in a state which is combined with case frame 210. At this time, a recess (214 of FIG. 4C) is formed on the location of the case frame 210 corresponding to the projection 234.

The plate 232 prevents disconnection from the case frame 210 in the upper direction. Also, a coupling structure of the projection 234 and the hook recess 214 prevent not only disconnection in the upper direction but also disconnection in the lower direction. Furthermore, the structure maintains the stability of movement of the scroll button 230.

As shown, the sensor unit 240 is adapted to the scroll button 230 and the main board 250, the sensor unit 240 includes a sensing part 241 formed on the scroll button 230 and a sensing means 242 adapted to the main board 250. However, the sensing means 242 is not limited in its application in the main board 250.

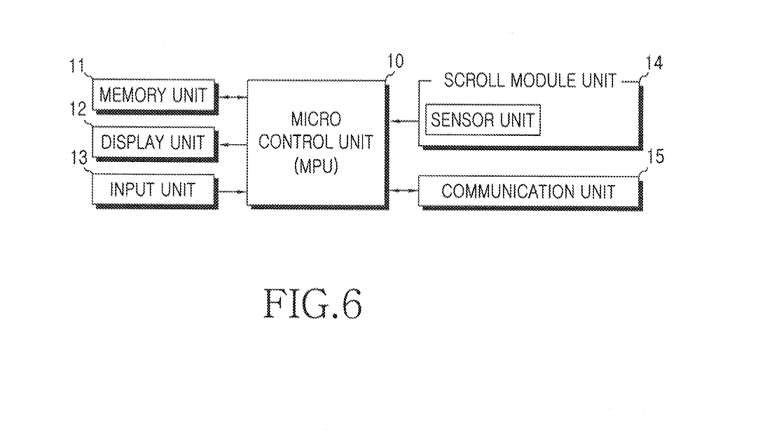

As an exemplary embodiment of the present invention, according to the location of the sensing part 241, the sensing means 242 detects the sensing part 241 so that the portable terminal 100 inputs a signal to a scroll module unit (14 of FIG. 6). The scroll module unit 14 may control to scroll the displayed information at the display unit 101 and control the scroll speed by a generated signal from the sensing unit 240.

Also, the sensing means 242 includes a plurality of recess portions. In particular, the scroll module unit 14 operates with a reception of the detecting signal of a recess portion. The recess portions provide an operation feeling of the scroll button to the user. Notably, the form of the recess portions may be formed in order not to disrupt the self-centering function.

For example, if a plurality of hall sensors is used as the sensing means 242 at the main board 250, a magnet may be installed at the lower portion of the scroll button 230. However, the invention is not so limited and other exemplary embodiments of the present invention include other sensing means, such as a photo sensor.

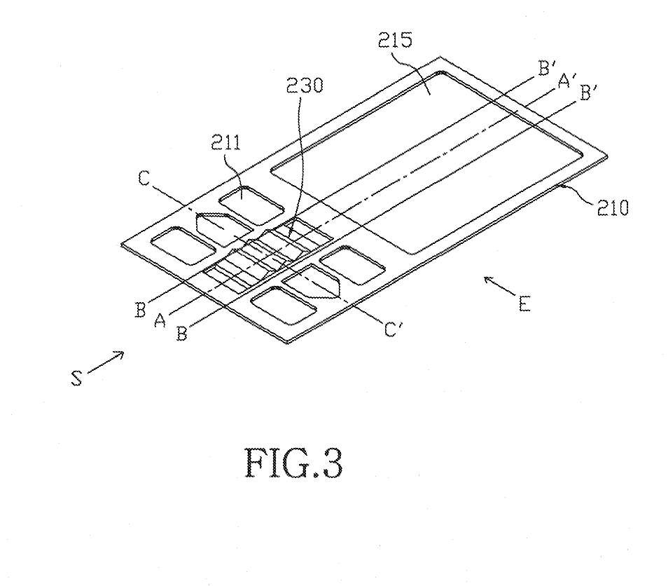

FIG. 3 illustrates a perspective view of a scroll button 230 of the scroll device 200. FIG. 4A illustrates a perspective view of a cross-section A-A′ of FIG. 3 in direction E. FIG. 4B illustrates a perspective view of a cross-section B-B′ of FIG. 3 in direction E. FIG. 4C illustrates a perspective view of a cross-section C-C′ of FIG. 3 in direction S.

Referring to FIG. 4A, the scroll button 230 is able to move a distance in upper and lower directions at through hole 212 of the case frame 210. Furthermore a plate (232 of FIG. 4B) is formed in order that the scroll button is not disconnected from the through hole 212.

Referring to FIG. 4B, the case frame 210 and the plate 232 of the scroll button 230 include spring grooves 213, 233. The tension springs are installed in the spring grooves 213, 233. In an exemplary implementation, one end of one of the tension springs 235 is fixed on a cut-off 235′ of the spring grooves 233 of the plate 232, another end of the one of the tension springs 235 is fixed on another cut-off 213′ of one of the spring grooves 213, 233 of the case frame 210. Consequently, when the user removes contact with the scroll button, the scroll button 230 is returned back to the original location automatically.

Referring to FIG. 4C, a projection 234 is formed at the plate 232 for moving in upper and lower direction from a state which is combined with case frame 210. At this time, a hook recess 214 is formed on the location of the case frame 210 corresponding to the projection 234.

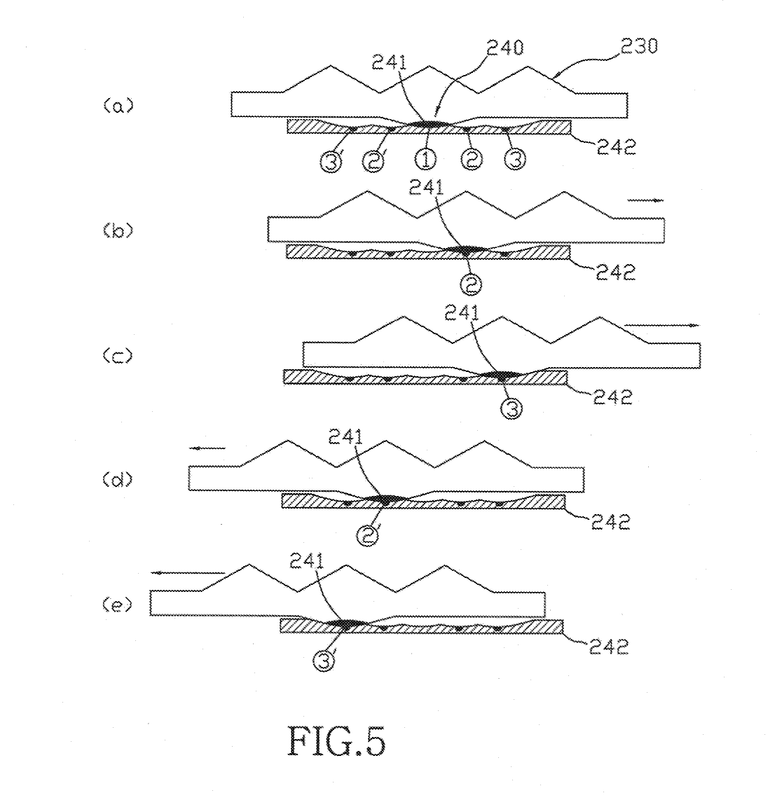

FIG. 5 illustrates an operative view of a sensor unit of a scroll device according to an exemplary embodiment of the present invention.

Referring to FIG. 5, (a) of FIG. 5 illustrates a ready state of the scroll operation.

According to an exemplary embodiment of the present invention, the sensing means includes a first sensing means \textcircled{2} which is located on the right side in the drawing (a), a second sensing means \textcircled{3}, a third sensing means \textcircled{2}′ which is located on the left side in the drawing (a), and a fourth sensing means \textcircled{3}′. The portable terminal 100 includes a scroll module for controlling the scroll speed according to a signal which is input from each location \textcircled{1}, \textcircled{2}, \textcircled{3}, \textcircled{2}′, \textcircled{3}′). A more detailed description will be provided later.

First, the sensing part 241 of the sensor unit 240 is located on the location \textcircled{1} of the sensing means 242 in the ready state. In location \textcircled{1}, the sensing means 242 does not detect any operation.

(b) and (c) of FIG. 5 illustrate the scroll operation in the light direction.

In (b), the first sensing means \textcircled{2} of the sensing means detects a movement of the sensing part 241 by moving from the location \textcircled{1} in the ready state to location \textcircled{2}. At this time, a detecting signal from the first sensing means of the sensing means 242 is input to a scroll module (a first scroll module). The portable terminal 100 receives a control signal of the first scroll module for controlling a specific scroll speed. If the sensing part 241 continuously is located in location \textcircled{2}, a scroll operation continuously will be accomplished with the specific scroll speed. Then, if the user removes contact, the scroll button 230 is returned back to the original location \textcircled{1} automatically by tension springs, and the scroll operation will be stopped.

In (c), the second sensing means \textcircled{3} of the sensing means detects the movement of the sensing part 241 by moving from location \textcircled{1} in the ready state or location \textcircled{2} to location \textcircled{3}. At this time, a detecting signal from the second sensing means of the sensing means 242 is input to a specific scroll module (a second scroll module). The portable terminal 100 receives control signal of the second scroll module for operating at a specific scroll speed, and the scroll speed is faster than the scroll speed in (b). If the sensing part 241 continuously is located in location \textcircled{3}, scroll operation continuously will be accomplished at the specific scroll speed. Then, if the user removes contact, the scroll button 230 is returned back to the original location \textcircled{1} automatically by tension spring, and the scroll operation will be stopped.

(d) and (e) illustrate operation in opposition direction, but (d) and (e) operate in substantially same method with respect to (b) and (c), and therefore the description will be omitted for conciseness.

Of course, the present invention is not limited to the 4 sensing means. For instance, exemplary embodiments of the present invention will be able to subdivide a scroll operation by applying more sensing means.

FIG. 6 illustrates a block diagram of a portable terminal according to an exemplary embodiment of the present invention.

Referring to FIG. 6, the portable terminal 100 includes a Micro Processor Unit (MPU) 10, a memory unit 11, a display unit 12, an input unit 13, a scroll module unit 14 and a communication unit 15.

First, the MPU 10 has various control functions in the portable terminal. In particular, according to an exemplary embodiment, the MPU 10 may scroll in the display unit 12 corresponding information according to the generated control signal from scroll module unit 14.

General descriptions of the memory unit 11, the display unit 12, the input unit 12, and the communication unit 15 will be omitted for conciseness.

The display unit 12 displays state information, limited numbers/characters, video and stationary image, etc. The display unit 12 may be used with a color LCD. In addition, according to an exemplary embodiment of the present invention, the display unit 12 displays corresponding information that is generated in the scroll module according to a control signal of the MPU 10.

The input unit 13 includes a various functional keys, such as numeral keys (0-9), menu keys, a cancel key, a confirmation key, a calling key, an end key, a internet access button, a navigation key, character input keys, etc. A key input date according to user's operation is provided to the MPU 10. In particular, below, the sensor unit (240 of FIG. 2) detects a location signal of the scroll button 230 by location movement of the scroll button (230 of FIG.2), the sensor unit 240 provides a control signal to the scroll module unit 14.

Referring back to FIG. 1, the scroll module unit 14 is provided a detected location signal generated in the scroll device 200, so that the scroll module unit 14 outputs the control signal for scroll operation.

The scroll module unit 14 provides the control signal to the MPU 10 for specific scroll operation by receiving the detected signal generated by the scroll device 200. The detected specific signal is provided to the specific scroll module (the first scroll module or the second scroll module) corresponding to the specific location. The scroll module unit 14 may be included in MPU 10.

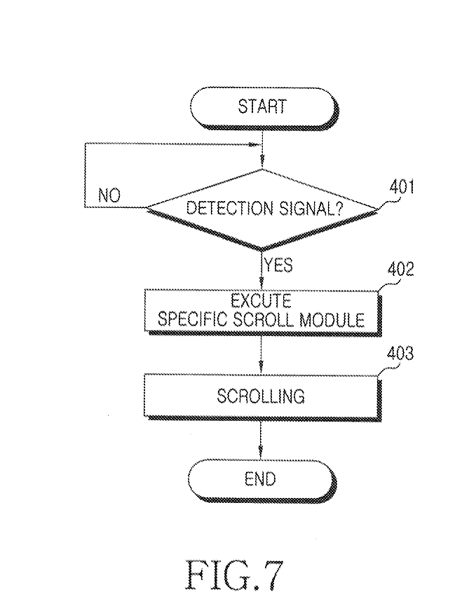

FIG. 7 illustrates a flowchart of a scroll method according to an exemplary embodiment of the present invention.

Referring to FIG. 7, in step 401, the MPU 10 identifies a detected signal from the sensor unit at a specific location. The specific location is a location that sensing means 242 may detect with the sensing part 241.

Then, if the detecting signal is identified, in step 402, the MPU 10 executes specific scroll module corresponding to the specific location.

According to an exemplary embodiment of the present invention, the specific scroll module is provided with a detected signal at the specific location, and the specific scroll module provides a signal for controlling the corresponding scroll operation to the MPU 10.

In step 403, the displayed information on the display unit 12 is scrolled at a scroll speed corresponding to the control signal.

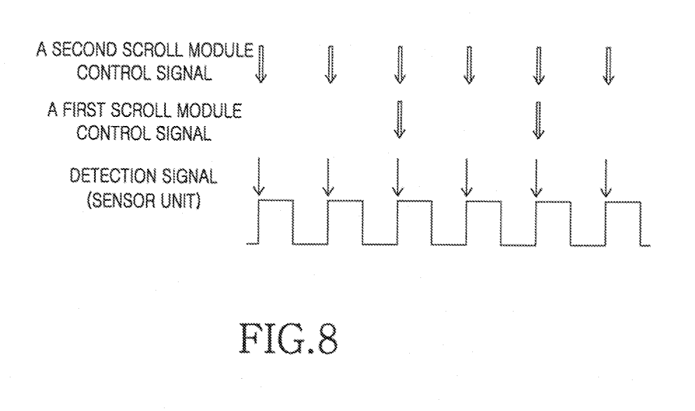

FIG. 8 illustrates a scrolling operation in a scrolling module according to an exemplary embodiment of the present invention.

Referring back to FIG. 5, for an exemplary scrolling operation, it is assumed that the signal, which is output in the sensing means 242, has 9 cycles per second, by the position movement of the sensing part 214.

Also, it is assumed that when the first scrolling module receives the detected signal, which is serially generated three times, the first scrolling module processes the detected signal when a 1st button is pushed, and the second scrolling module processes the detected signal when a button is pushed another time when the detected signal receives each time.

Then, if the scrolling bottom of an exemplary embodiment of the present invention is located at \textcircled{2}, the first detection means of sensing means 242 detects a signal and send the detected signal to the first scrolling module. The first scrolling module, which receives the detected signal, will send a control signal to a portable terminal 100, to scroll three times per second,

Also, if the scrolling bottom of an exemplary embodiment of the present invention is located in \textcircled{3}, the second detection means of the sensing means 242 detects a signal send the detected signal to the second scrolling module. The second scrolling module will send a control signal to a portable terminal 100, to scroll 3 times faster than the first scrolling module.

By using an apparatus and a method for scrolling according to exemplary embodiments of the present invention, a portable terminal is able to be made thin. And with the scroll device and method according to exemplary embodiments of the present invention, a user may perform Internet searching, document editing, etc. more conveniently, and hence a utilization of service and user preferences rise.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A scroll device, the device comprising:
a scroll button installed and partially projected on a case frame of an apparatus, the scroll button being able to move in forward and backward directions by manipulation;
a sensing means for detecting movement of the scroll button; and
a control unit for scrolling displayed information on a display unit of the apparatus in a direction corresponding to the movement detected by the sensing means.

2. The device of claim 1, wherein the scroll button is installed to be movable on the case frame.

3. The device of claim 1, wherein the scroll button comprises a handling portion partially protruded on the case frame, a plate having larger area than the area of the handling portion such that the plate prevents the scroll button from detaching from the case frame, wherein the handling portion and the plate comprise one body and wherein the plate and the case frame have a hook type coupling structure.

4. The device of claim 3, wherein the scroll button further comprises a button return means for a self-centering function.

5. The device of claim 4, wherein the button return means comprises at least one spring installed on either side of the handling portion with respect to the middle of the scroll button, the at least one spring having substantially the same tension,
wherein one end of the spring is coupled to the scroll button and the other end of the spring is coupled to the case frame.

6. The device of claim 5, wherein the button return means further comprises a spring groove formed on the surface facing with a lower case frame of the handling portion, wherein the spring is installed in the spring groove.

7. The device of claim 6, wherein the spring comprises at least one of a compression coil spring and a tension coil spring.

8. The device of claim 1, wherein the sensing means comprises a magnet installed on the lower portion of the scroll button and a plurality of hall sensors disposed on a main board of the apparatus.

9. The device of claim 8, wherein the control unit controls a scrolling speed according to the detection of respective hall sensors.

10. The device of claim 1, wherein the sensing means comprises a photo sensor.

11. A portable terminal, the terminal comprising:
a main body having a display unit;
a scroll device installed on an area of the main body, wherein the scroll device comprises;
a scroll button installed and partially projected on a case frame of an apparatus, the scroll button being able to move in forward and backward directions by manipulation;
a sensing means for detecting the movement of the scroll button; and
a control unit for scrolling displayed information on a display unit of the apparatus in a direction corresponding to the detecting signal of the sensing means.

12. The terminal of claim 11, wherein the scroll button is installed to be movable on the case frame.

13. The terminal of claim 11, wherein the scroll button comprises a handling portion partially protruded on the case frame, a plate having larger area than the area of the handling portion such that the plate prevents the scroll button from detaching from the case frame, wherein the handling portion and the plate comprise one body, and wherein the plate and the case frame have a hook type coupling structure.

14. The terminal of claim 13, wherein the scroll button further comprises a button return means for a self-centering function.

15. The terminal of claim 14, wherein the button return means comprises at least one spring installed on either side of the handling portion with respect to the middle of the scroll button, the at least one of spring having substantially the same tension, wherein one end of the spring is coupled to the scroll button and another end of the spring is coupled to the case frame.

16. The terminal of claim 15, wherein the button return means further comprises a spring groove formed on the surface facing a lower case frame of the handling portion, wherein the spring is installed in the spring groove.

17. The terminal of claim 16, wherein the spring comprises at least one of a compression coil spring and a tension coil spring.

18. The terminal of claim 11, wherein the sensing means comprises a magnet installed on the lower portion of the scroll button and a plurality of hall sensors disposed on a main board of the apparatus.

19. The terminal of claim 18, wherein the control unit controls a scrolling speed according to the detection of respective hall sensors.

20. The terminal of claim 11, wherein the sensing means comprising a photo sensor.

21. A method for scrolling of a scroll device including a scroll button installed and partially projected on the case frame of an apparatus, the scroll button being able to move in forward and backward directions by manipulation, a sensing means for detecting the movement of the scroll button and a control unit for scrolling displayed information on a display unit of the apparatus in a direction corresponding to the detecting signal of the sensing means, the method comprising:
detecting a movement of the scroll button; and
scrolling the displayed information on the display unit of the apparatus corresponding to a detection signal of the sensing means.

22. The method of claim 21, wherein the sensing means comprises at least one of a magnet detecting sensor and a photo sensor for detecting the movement of the scroll button.

23. The method of claim 22, wherein the control unit controls a scrolling speed according to the detection of the sensing means.
